(19) United States
(12) Patent Application Publication
(10) Pub. No.: US 2024/0320129 A1
(43) Pub. Date: Sep. 26, 2024

(54) REMOTE DEBUGGING METHOD AND APPARATUS

(71) Applicants: SHANGHAI KONG INTELLIGENT BUILDING CO., LTD, SHANGHAI (CN); GD MIDEA HEATING & VENTILATING EQUIPMENT CO., LTD., FOSHAN (CN)

(72) Inventors: Wentian HUANG, SHANGHAI (CN); Jie YAN, SHANGHAI (CN)

(21) Appl. No.: 18/578,722

(22) PCT Filed: Sep. 5, 2022
(86) PCT No.: PCT/CN2022/117083

§ 371 Date: Jan. 12, 2024

(30) Foreign Application Priority Data
Nov. 1, 2021 (CN) 202111283676.2

(51) Int. Cl. G06F 11/36

(52) U.S. Cl. CPC G06F 11/366; G06F 11/3664

(57) ABSTRACT

Provided are a remote debugging method and apparatus, an electronic device, a computer-readable storage medium, a computer program product, and a computer program. The method includes receiving first operation data of a controller; according to a debugging instruction, acquiring the first operation data of the controller to be debugged, and the debugging instruction includes identification information of the controller to be debugged; and generating debugging data according to the first operation data, and sending the debugging data to the controller to be debugged.

### CROSS-REFERENCES TO RELATED APPLICATIONS

The present disclosure is a national phase application of International Application No. PCT/CN2022/117083, filed on Sep. 5, 2022, which claims priority to Chinese Patent Application No. 202111283676.2, filed on Nov. 1, 2021, the entire content of which is incorporated herein by reference.

### FIELD

The present disclosure relates to the field of intelligent control, and specifically to a remote debugging method and device therefor, an electronic device, computer-readable storage medium, computer program product and computer program.

### BACKGROUND

A controller belongs to the building automatic control product, where the building equipment may be subjected to some adjustments and debugging according to the owner's demand. In the related art, when debugging the controller, technicians need to debug on site, which however are unable to arrive at the site for debugging at once when the customer has demand. It is not in time and of high cost.

### SUMMARY

The present disclosure aims to solve at least one of the problems in the related art to a certain degree.

According to some embodiments of the present disclosure, there is provided a remote debugging method, for a cloud server side, including: receiving first operating data of a controller; acquiring the first operating data of a controller to be debugged according to a debugging instruction, and the debugging instruction includes a first identification of the controller to be debugged; and generating debugging data according to the first operating data, and transmitting the debugging data to the controller to be debugged.

According to some embodiments of the present disclosure, there is provided another remote debugging method, for a client side, including: transmitting first operating data of a controller; and receiving debugging data corresponding to a controller to be debugged, and debugging the controller to be debugged according to the debugging data.

According to some embodiments of the present disclosure, there is provided a remote debugging device, for a cloud server side, including: a first receiving device, configured to receive first operating data of a controller; a data acquiring device, configured to acquire the first operating data of a controller to be debugged according to a debugging instruction, and the debugging instruction includes a first identification of the controller to be debugged; and a data transmitting device, configured to generate debugging data according to the first operating data, and transmit the debugging data to the controller to be debugged.

According to some embodiments of the present disclosure, there is provided another remote debugging device, for a client side, including: a transmitting device, configured to transmit first operating data of a controller; and a receiving device, configured to receive debugging data corresponding to a controller to be debugged, and debug the controller to be debugged according to the debugging data.

According to some embodiments of the present disclosure, there is provided an electronic device, including: at least one processor; and a memory, communicated to said at least one processor, and the memory has stored therein executable instructions that, when executed by said at least one processor, achieve a remote debugging method according to the embodiments of the present disclosure.

According to some embodiments of the present disclosure, there is provided a non-transitory computer-readable storage medium having stored therein computer executable instructions that, when executed by a computer, achieves a remote debugging method according to the embodiments of the present disclosure.

According to some embodiments of the present disclosure, there is provided a computer program product, including a computer program that, when executed by a processor, achieves a remote debugging method according to the first or second aspect of embodiments of the present disclosure.

According to some embodiments of the present disclosure, there is provided a computer program, including a computer program code that, when executed by a computer, implements a remote debugging method according to the embodiments of the present disclosure.

### BRIEF DESCRIPTION OF THE DRAWINGS

FIG. 1 is a block diagram showing a remote debugging method according to at least one of examples of the present disclosure.

FIG. 2 is a schematic diagram showing a remote debugging according to at least one of examples of the present disclosure.

FIG. 3 is a block diagram showing a remote debugging method according to at least one of examples of the present disclosure.

FIG. 4 is a block diagram showing transmission of debugging data to a controller to be debugged, according to at least one of examples of the present disclosure.

FIG. 5 is a schematic diagram showing acquirement for debugging data, according to at least one of examples of the present disclosure.

FIG. 6 is a block diagram showing reception to second operating data of a controller to be debugged, according to at least one of examples of the present disclosure.

FIG. 7 is a schematic diagram showing generation of a target data architecture, according to at least one of examples of the present disclosure.

FIG. 8 is a block diagram showing a remote debugging method according to at least one of examples of the present disclosure.

FIG. 9 is a block diagram showing another remote debugging method according to at least one of examples of the present disclosure.

FIG. 10 is a block diagram showing transmission of second operating data, according to at least one of examples of the present disclosure.

FIG. 11 is a schematic diagram showing acquirement for second operating data, according to at least one of examples of the present disclosure.

FIG. 12 is a schematic diagram showing a remote debugging device according to at least one of examples of the present disclosure.

FIG. 13 is a schematic diagram showing a remote debugging device according to at least one of examples of the present disclosure.

FIG. 14 is a schematic diagram showing an electronic device according to at least one of examples of the present disclosure.

### DETAILED DESCRIPTION OF THE DISCLOSURE

Reference will be made in detail to embodiments of the present disclosure. The same or similar elements and the elements having same or similar functions are denoted by like reference numerals throughout the descriptions. The embodiments described herein with reference to drawings are illustrative, and used to generally understand the present disclosure. The embodiments shall not be construed to limit the present disclosure.

FIG. 1 is a block diagram showing a remote debugging method provided in at least one of examples of the present disclosure. As shown in FIG. 1, the remote debugging method includes the following steps S101-S103.

At the S101, first operating data of a controller is received.

There are generally a lot of environmental monitoring equipment and electromechanical equipment in the interior of buildings. The equipment belonging to a same kind builds an integrated subsystem, through a controller. In a building, there are generally many subsystems, such as security subsystem, air conditioning subsystem, cold and heat source subsystem, water supply and drainage subsystem, power transformation and distribution subsystem, lighting subsystem, elevator subsystem and so on.

To achieve a remote debugging to the controller, the controller may transmit its first operating data in real time to a remote device for performing debugging. In some examples, the remote device for performing debugging may be a server, a cloud, a control terminal, a debugging terminal, etc., that is, the server, the cloud, the control terminal, the debugging terminal, etc. receive the first operating data of the controller.

At the S102, the first operating data of a controller to be debugged is acquired according to a debugging instruction, where the debugging instruction includes a first identification of the controller to be debugged.

In some examples, the controller may transmit the first operating data, by itself, to the remote device for performing debugging. In some examples, the controller may be a direct digital control (DDC) controller, a programmable logic controller (PLC) and so on.

In other examples, the controller may transmit the first operating data to a client side, and the client side unifies and manages the controller, and transmits the first operating data to the remote device for performing debugging.

The remote device for performing debugging such as the server, the cloud, the control terminal, the debugging terminal, etc., after receiving the debugging instruction, acquires the first operating data according to the debugging instruction and the first identification of the controller to be debugged included in the debugging instruction. The debugging instruction may be generated according to external instructions of debugging personnel or customers, or be automatically generated according to internal debugging strategies.

At the S103, debugging data is generated according to the first operating data, and the debugging data is transmitted to the controller to be debugged.

The debugging personnel start to debug according to the received first operating data. In some examples, debugging may be interface dragging, compilation deployment, etc. Based on debugging by debugging personnel, the device performing debugging generates the debugging data and transmits the debugging data to the controller to be debugged.

The present disclosure provides in at least one of examples the remote debugging method, including: receiving the first operating data of a controller; acquiring the first operating data of a controller to be debugged according to the debugging instruction, where the debugging instruction includes the identification of the controller to be debugged; and generating the debugging data according to the first operating data, and transmitting the debugging data to the controller to be debugged. According to examples of the present disclosure, the device performing debugging may acquire real-time information of several controllers, and the debugging personnel can remotely acquire the information of the controllers through the device performing debugging to remotely debug the controller, which is more convenient and faster with reduced costs.

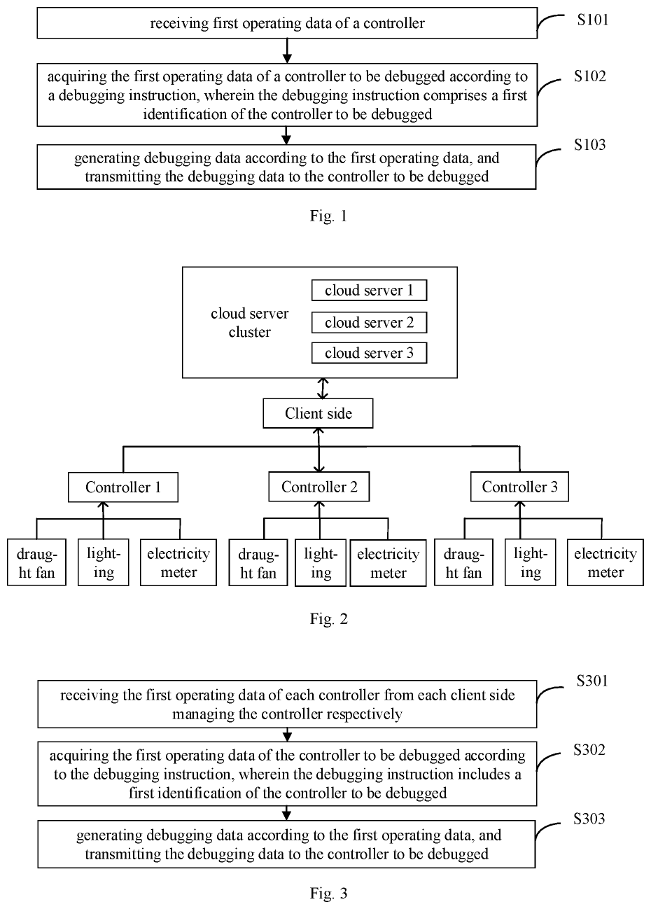

FIG. 2 is a schematic diagram showing a remote debugging system according to at least one of examples of the present disclosure. The remote debugging system includes: cloud servers, client sides and controllers, where one cloud server may correspond to one or more client side(s), each of which manages one or more controller(s).

In some examples, the controller under the management of the client side may be a direct digital control (DDC) controller (known as DDC controller). When the controller under the management of the client side is a DDC controller, a DDC system may include central control equipment, field DDC controller, communication network, and corresponding sensors, actuators, regulating valves and other components. There are generally a lot of environmental monitoring equipment and electromechanical equipment in the interior of buildings. The equipment belonging to a same kind builds an integrated subsystem, through a DDC controller. In a building, there are generally many subsystems, such as security subsystem, air conditioning subsystem, cold and heat source subsystem, water supply and drainage subsystem, power transformation and distribution subsystem, lighting subsystem, elevator subsystem and so on.

The remote debugging method provided in examples of the present disclosure is illustrated below, by taking the remote debugging system as shown in FIG. 2 as an example.

FIG. 3 is a block diagram showing a remote debugging method according to at least one of examples of the present disclosure. As shown in FIG. 3, the remote debugging method includes the following steps S301-S303.

At the S301, the first operating data of each controller is received from each client side managing the controller respectively.

As shown in FIG. 2, the controller may manage the monitoring sub-system, which is under the control of the controller, and transmit the first operating data representing an operating state of the monitoring subsystem to the client side, which transmits the first operating data sent by the controller to the cloud server, to realize intensive management of the client side. The first operating data includes resource usage state data and/or configuration information of the controller to be debugged. For example, the configuration information may include html, css, js, svg, icon, etc., and the resource usage state data may include real-time data of hardware. In some examples, the cloud server may implement a two-level storage mechanism. On the one hand, the binding relationship between the cloud server and the client side and the controller managed by the client side would be persisted locally, to form a mapping relationship that can be read on demand and can prevent from loss resulting from power failure. On the other hand, the cloud server would store this binding relationship in memory to achieve high-speed reading and high-speed matching.

In some examples, when the cloud server receives the first operating data transmitted by the client side, heartbeat data may be sent to the client side at set intervals to keep the pipeline alive.

At the S302, the first operating data of the controller to be debugged is acquired according to the debugging instruction, where the debugging instruction includes a first identification of the controller to be debugged.

When the controller requires debugging, the debugging personnel may communicate with the cloud server through a terminal device, for example, through the browser of the terminal device, and transmit the debugging instruction for debugging the controller to be debugged to the cloud server, and the cloud server receives the debugging instruction sent by the debugging personnel through the browser of the terminal device. The debugging instruction includes identification of the controller to be debugged, such as an IP address of the controller to be debugged. In some examples, the terminal device may be a mobile phone, tablet, computer, etc.

The cloud server, according to the received debugging instruction and the identification of the controller to be debugged therein, extracts the first operating data corresponding to the controller to be debugged. The first operating data includes resource usage state data and/or configuration information of the controller to be debugged. For example, the configuration information may include html, css, js, svg, icon, etc., and the resource usage state data may include real-time data of hardware.

At the S303, debugging data is generated according to the first operating data, and the debugging data is transmitted to the controller to be debugged.

The debugging personnel start to debug according to the first operating data as received. In some examples, debugging may be interface dragging, compilation deployment, etc. Based on debugging of debugging personnel, the cloud server generates the debugging data and transmits the debugging data to a target client side to which the controller to be debugged belongs, and the target client side transmits the debugging data to the controller to be debugged.

The present disclosure provides in examples the remote debugging method, including: receiving the first operating data of each controller from each client side managing the controller respectively; acquiring the first operating data of a controller to be debugged according to the debugging instruction, where the debugging instruction includes the identification of the controller to be debugged; and generating the debugging data according to the first operating data, and transmitting the debugging data to the controller to be debugged. According to examples of the present disclosure, the cloud server may acquire real-time information of the controller managed by several client sides, and the debugging personnel can remotely acquire the information of the controllers from the cloud server through the terminal device, to remotely debug the controller, which is more convenient and faster with reduced costs.

In some examples, when there are multiple cloud servers, all cloud servers may be grouped into a cloud server cluster, and a balancing server is set in the cloud server cluster. Debugging personnel send the debugging instruction to the balancing server in the cloud server cluster, which determines a cloud server for processing the debugging instruction according to load status of each cloud server in the cluster, and transmits the debugging instruction to the determined cloud server, to realize a load balance in the cloud server cluster. For example, if there are three cloud servers and one balancing server in the cloud server cluster and two of them are working, the balancing server can distribute the debugging instruction to the third cloud server.

In some examples, after receiving the first operating data transmitted by the server, it is determined whether the first operating data carries the project identification and the client's identification; and if the first operating data does not carry the project identification or the client's identification, a filter may be set on the cloud server, where the filter searches for the project identification or the client's identification based on the anti-theft chain technology in Hyper Text Transfer Protocol (HTTP), and adds the project identification and/or the second identification into the first operating data. For example, the project information corresponding to the controller to be debugged may be “** Park”, and the identification of the client side to which the controller to be debugged belongs may be an IP address of the client side.

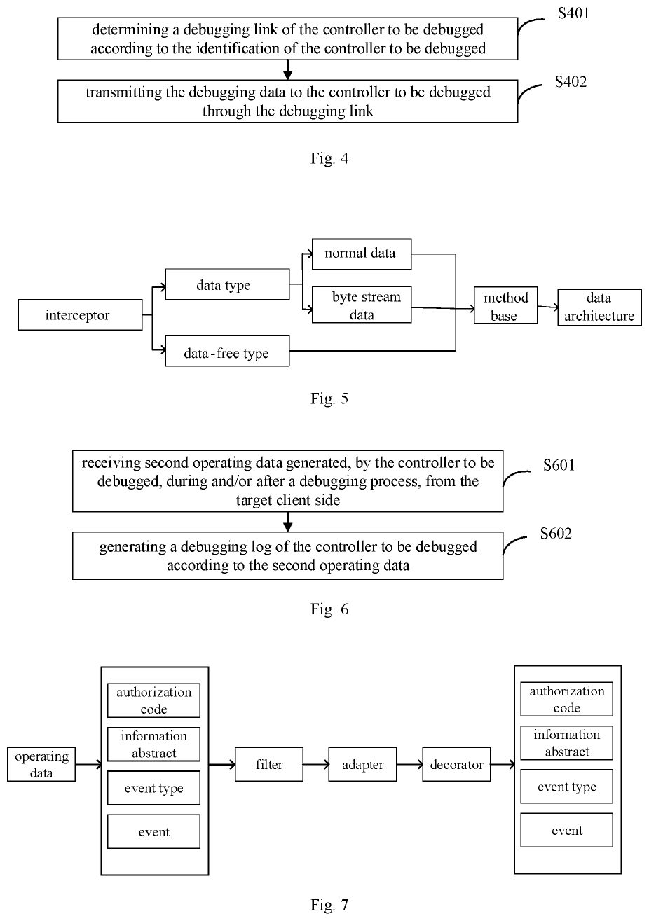

FIG. 4 is a block diagram showing a remote debugging method according to at least one of examples of the present disclosure, which is executed by a cloud server side. As shown in FIG. 4, the transmission of debugging data to a target client side to which a controller to be debugged belongs includes the following steps S401-S402.

At the S401, a debugging link of the controller to be debugged is determined according to the identification of the controller to be debugged.

The project identification of the controller to be debugged and the second identification of the client side to which the controller to be debugged belongs are determined according to the first identification of the controller to be debugged; and the debugging link is generated based on the first identification and the project identification of the controller to be debugged, and the second identification of the target client side to which the controller to be debugged belongs. For example, the project information corresponding to the controller to be debugged may be “** Park”, the second identification of the client side to which the controller to be debugged belongs may be an IP address of the client side, and the first identification of the controller to be debugged may be an IP address of the controller to be debugged.

At the S402, the debugging data is transmitted to the controller to be debugged through the debugging link.

FIG. 5 is a schematic diagram showing acquirement for debugging data. As shown in FIG. 5, an interceptor is set on the cloud server for determining a debugging type of the debugging instruction, for example, the debugging type may be a data type or a data-free type, where the data type may be divided into a normal data type and a byte stream data type. Based on the debugging type, a method base required to be called for the debugging type is acquired, and a data architecture, for debugging correspondingly, as the debugging data, is generated. After acquiring the debugging data, the debugging data is transmitted to the target client side through the debugging link, and further transmitted to the controller to be debugged, to realize debugging for the controller to be debugged.

In some examples, the method base may include a P method base and a G method base. The method base automatically identifies whether the debugging type is the data type or data-free type and a request mode. If it is a get request, it will enter the G method base, which has methods calling html, svg, png, etc.; if it is a Post request, it will enter the P method base, which contains user-configured methods, time methods, node methods, language methods, etc.

According to at least one examples of the present disclosure, by the method the debugging link of each controller is determined, and the cloud server can accurately and quickly find the target client side, to complete the debugging of the controller.

FIG. 6 is a block diagram showing a remote debugging method according to at least one of examples of the present disclosure, which is executed by a cloud server side. As shown in FIG. 6, subsequent to transmitting the debugging data to the target client side to which the controller to be debugged belongs, the method further includes the following steps S601-S602.

At the S601, second operating data generated, by the controller to be debugged, during and/or after a debugging process, is received from the target client side.

The second operating data generated, by the controller to be debugged, during and/or after the debugging process, is received from the target client side. The second operating data includes resource usage state data and/or configuration information of the controller to be debugged. For example, the configuration information may include html, css, js, svg, icon, etc., and the resource usage state data may include real-time data of hardware.

After receiving the second operating data transmitted by the server, it is determined whether the second operating data carries the project identification and the client's identification; and if the second operating data does not carry the project identification or the client's identification, the project identification or the client's identification may be searched based on the anti-theft chain technology in HTTP, and added into the second operating data.

FIG. 7 is a schematic diagram showing generation of a target data architecture. As shown in FIG. 7, the received second operating data is collated for removing unnecessary information and retain key information, to reduce the amount of data transmitted. The second operating data with unnecessary information removed is adjusted and cleaned structurally on a hierarchical structure of authorization code, information abstract, event type and event, and finally converted into a relatively fixed data structure through filters, adapters and decorators, to generate the target data architecture.

At the S602, a debugging log of the controller to be debugged is generated according to the second operating data.

The debugging log of the debugged controller is generated according to the second operating data which is transmitted by the client side and generated during and/or after the debugging process. The debugging log may record debugging requesting data, debugging data and debugging result data.

According to at least one of examples of the present disclosure, the cloud server receives the second operating data generated, by the controller to be debugged, during and/or after the debugging process, and generates the debugging log, which is beneficial for debugging personnel to monitor information of the debugged controller in real time, and the log recorded in the cloud server facilitates subsequent reference when required.

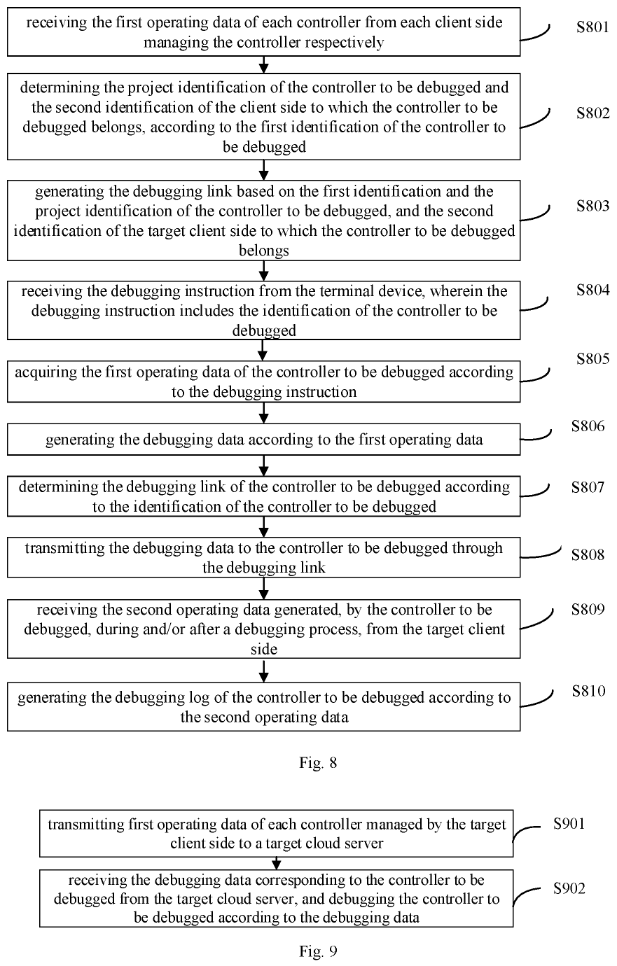

Continuing to take the debugging structure of FIG. 2 as an example, FIG. 8 is a schematic diagram of a remote debugging method according to at least one of examples of the present disclosure, which is executed by a cloud server side. As shown in FIG. 8, the remote debugging method includes the following steps S801 to S810.

At the S801, the first operating data of each controller is received from each client side managing the controller respectively.

At the S802, the project identification of the controller to be debugged and the second identification of the client side to which the controller to be debugged belongs are determined according to the first identification of the controller to be debugged.

At the S803, the debugging link is generated based on the first identification and the project identification of the controller to be debugged, and the second identification of the target client side to which the controller to be debugged belongs.

The steps S801-S803 may apply to implementation models according to examples of the present disclosure, which will be not repeated herein.

At the S804, the debugging instruction is received from the terminal device, where the debugging instruction includes the identification of the controller to be debugged.

At the S805, the first operating data of the controller to be debugged is acquired according to the debugging instruction.

At the S806, the debugging data is generated according to the first operating data.

At the S807, the debugging link of the controller to be debugged is determined according to the identification of the controller to be debugged.

At the S808, the debugging data is transmitted to the controller to be debugged through the debugging link.

The steps S804-S808 may apply to implementation models according to examples of the present disclosure, which will be not repeated herein.

At the S809, the second operating data generated, by the controller to be debugged, during and/or after a debugging process, is received from the target client side.

At the S810, the debugging log of the controller to be debugged is generated according to the second operating data.

The steps S809-S810 may apply to implementation models according to examples of the present disclosure, which will be not repeated herein.

The present disclosure further provides in examples the remote debugging method, including: receiving the first operating data of each controller from each client side managing the controller respectively; acquiring the first operating data of a controller to be debugged according to the debugging instruction, where the debugging instruction includes the identification of the controller to be debugged; and generating the debugging data according to the first operating data, and transmitting the debugging data to the target client side to which the controller to be debugged belongs. According to examples of the present disclosure, the cloud server may acquire real-time information of the controller managed by several client sides, and the debugging personnel can remotely acquire the information of the controllers from the cloud server through the terminal device, to remotely debug the controller, which is more convenient and faster with reduced costs.

An executive subject of the remote debugging method provided by the present disclosure may directly interact with the controller to be debugged with data and/or information. If the executive subject is a client side, data and/or information interaction may be performed with the controller to be debugged. If the executive subject is a cloud server, data and/or information interaction may be performed with the controller to be debugged through the client side.

In some examples, subsequent to transmitting the debugging data to the controller to be debugged, the method further includes: receiving the second operating data generated, by the controller to be debugged, during and/or after the debugging process; and generating the debugging log of the controller to be debugged according to the second operating data.

In some examples, transmitting the debugging data to the controller to be debugged includes: determining the debugging link of the controller to be debugged according to the first identification of the controller to be debugged; and transmitting the debugging data to the controller to be debugged through the debugging link.

In some examples, subsequent to acquiring the first operating data of a controller to be debugged, the remote debugging method further includes: determining the project identification of the controller to be debugged and the second identification of a client side to which the controller to be debugged belongs, according to the first identification of the controller to be debugged; and generating the debugging link based on the first identification and the project identification of the controller to be debugged, and the second identification of a target client side to which the controller to be debugged belongs.

In some examples, subsequent to acquiring the first operating data or the second operating data, the remote debugging method further includes: determining whether the first operating data or the second operating data carries the project identification and the second identification of the client side; and adding the project identification and/or the second identification into the first operating data or the second operating data, in response to the determination that the project identification and/or the second identification of the client side are/is not carried.

In some examples, prior to transmitting the debugging data to the controller to be debugged, the remote debugging method further includes: acquiring the debugging type of the debugging instruction, acquiring the method base required to be called for the debugging type according to the debugging type, and generating the data architecture, for debugging correspondingly, as the debugging data.

In some examples, subsequent to acquiring the first operating data or the second operating data, the remote debugging method further includes: collating the first operating data or the second operating data to obtain key information; and adjusting the key information structurally to generate the target data architecture.

Continuing to take the debugging structure of FIG. 2 as an example, FIG. 9 is a schematic diagram of a remote debugging method according to at least one of examples of the present disclosure, which is executed by a target client side. As shown in FIG. 9, the remote debugging method includes the following steps S901-S902.

At the S901, first operating data of each controller managed by the target client side is transmitted to a target cloud server.

The client side transmits the first operating data of each controller under its management in real time to the target cloud server. The first operating data includes resource usage state data and/or configuration information of the controller to be debugged. For example, the configuration information may include html, css, js, svg, icon, etc., and the resource usage state data may include real-time data of hardware.

At the S902, debugging data corresponding to a controller to be debugged is received from the target cloud server, and the controller to be debugged is debugged according to the debugging data.

When debugging personnel debugs the controller to be debugged, the client side receives the debugging data corresponding to the controller to be debugged from the target cloud server, and debugs the controller to be debugged according to the debugging data.

The present disclosure further provides in examples another remote debugging method, including: transmitting the first operating data of each controller managed by the target client side to the target cloud server; and receiving the debugging data corresponding to the controller to be debugged from the target cloud server, and debugging the controller to be debugged according to the debugging data. According to examples of the present disclosure, the cloud server may acquire real-time information of the controller managed by several client sides, and the debugging personnel can remotely acquire the information of the controllers from the cloud server through the terminal device, to remotely debug the controller, which is more convenient and faster with reduced costs.

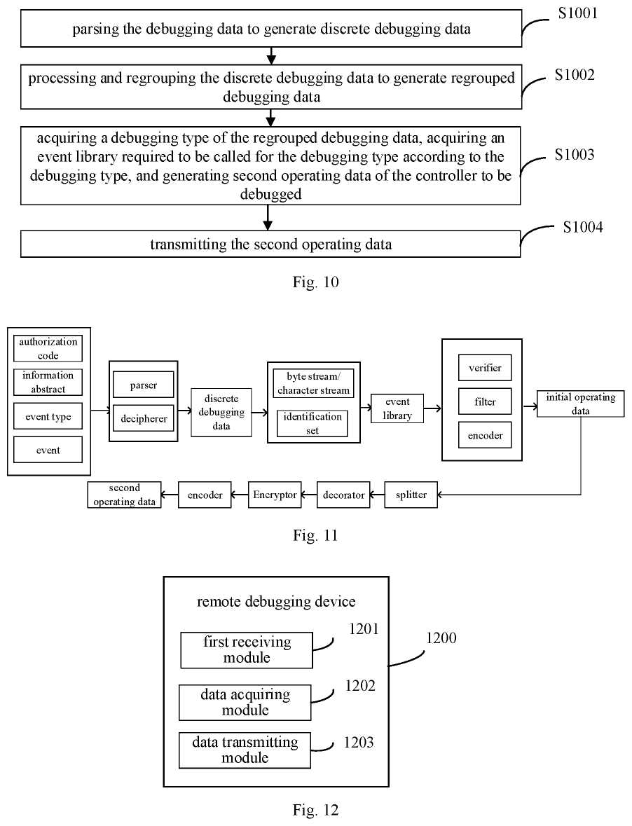

Continuing to take the debugging structure of FIG. 2 as an example, FIG. 10 is a schematic diagram of a remote debugging method according to at least one of examples of the present disclosure, which is executed by a target client side. As shown in FIG. 10, subsequent to receiving the debugging data corresponding to the controller to be debugged from the target cloud server, the method further includes the following steps S1001-S1004.

At the S1001, the debugging data is parsed to generate discrete debugging data.

FIG. 11 is a schematic diagram showing acquirement for second operating data. As shown in FIG. 11, the debugging data, received by the client side from the cloud server, is parsed with a parser and a decipherer, to generate several discrete debugging data, which may divided into a byte stream/character stream and an identification set.

At the S1002, the discrete debugging data is processed and regrouped to generate the regrouped debugging data.

The several discrete debugging data is processed, and then regrouped by a decorator, to generate the regrouped debugging data.

At the S1003, a debugging type of the regrouped debugging data is acquired, an event library required to be called for the debugging type is acquired according to the debugging type, and second operating data of the controller to be debugged is generated.

The debugging type the regrouped debugging data corresponds to is acquired. For example, the regrouped debugging data may correspond to html, css, js, svg, icon, etc., or real-time data of hardware. As shown in FIG. 11, according to the debugging type, the event library required to be called for the debugging type is acquired, and initial operating data of the controller to be debugged is generated through a verifier, a filter, and an encoder. The initial operating data is split, decorated, encrypted and encoded to generate the second operating data finally. The second operating data includes resource usage state data and/or configuration information of the controller to be debugged. The cloud server determines the debugging type, and according to different debugging types goes to different event libraries, which contains corresponding sub-events and an addressing mapping table preset in advance, and the identification of a target controller can be quickly and efficiently found through the addressing mapping table. The addressing mapping table is made according to the network topology structure prepared in advance. After the cloud server finds a target address, the target address is returned back to an initial result set which has tracing markers of relevant events. With the tracing marker, an original debugging instruction could be found in an addresser, forming a closed loop. In some examples, the addressing mapping table may be stored in the addresser, which implements a two-level mechanism, one persistent to disk and the other resident in memory, to achieve high speed reading and matching.

At the S1004, the second operating data is transmitted.

Subsequent to acquiring the second operating data, the second operating data generated, by the controller to be debugged, during and/or after the debugging process is transmitted to the target cloud server through debugging link.

According to at least one of examples of the present disclosure, the client side transmits the second operating data generated, by the controller to be debugged, during and/or after the debugging process to the target cloud server, which is beneficial for debugging personnel to monitor information of the debugged controller in real time.

In some examples, subsequent to receiving the debugging data corresponding to a controller to be debugged, and debugging the controller to be debugged according to the debugging data, the remote debugging method further includes: transmitting the second operating data generated, by the controller to be debugged, during and/or after the debugging process.

In some examples, the operating data of the controller includes resource usage state data and/or configuration information of the controller to be debugged.

In some examples, subsequent to receiving debugging data corresponding to a controller to be debugged, the remote debugging method further includes: parsing the debugging data to generate discrete debugging data; processing and regrouping the discrete debugging data to generate regrouped debugging data; acquiring a debugging type of the regrouped debugging data, acquiring an event library required to be called for the debugging type according to the debugging type, and generating second operating data of the controller to be debugged; and transmitting the second operating data.

FIG. 12 is a schematic diagram showing a remote debugging device according to at least one of examples of the present disclosure. As shown in FIG. 12, the remote debugging device 1200 is installed at a cloud server, including: a first receiving device 1201, a data acquiring device 1202 and a data transmitting device 1203.

The first receiving device 1201 is configured to receive first operating data of a controller.

The data acquiring device 1202 is configured to acquire the first operating data of a controller to be debugged according to a debugging instruction, where the debugging instruction includes a first identification of the controller to be debugged.

The data transmitting device 1203 is configured to generate debugging data according to the first operating data, and transmit the debugging data to the controller to be debugged.

In some examples, the data transmitting device 1203 is further configured to receive second operating data generated, by the controller to be debugged, during and/or after a debugging process; and generate a debugging log of the controller to be debugged according to the second operating data.

In some examples, the operating data of the controller includes resource usage state data and/or configuration information of the controller to be debugged.

In some examples, the data transmitting device 1203 is further configured to determine a debugging link of the controller to be debugged according to the first identification of the controller to be debugged; and transmit the debugging data to the controller to be debugged through the debugging link.

In some examples, the first receiving device 1201 is further configured to determine a project identification of the controller to be debugged and a second identification of a client side to which the controller to be debugged belongs, according to the first identification of the controller to be debugged; and generate the debugging link based on the first identification and the project identification of the controller to be debugged, and the second identification of a target client side to which the controller to be debugged belongs.

In some examples, the remote debugging device 1200 further includes an identification determining device 1204, configured to determine whether the first operating data or the second operating data carries the project identification and the second identification of the client side; and adding the project identification and/or the second identification into the first operating data or the second operating data in response to the determination that the project identification and/or the second identification of the client side are/is not carried.

In some examples, the data transmitting device 1203 is further configured to acquire a debugging type of the debugging instruction, acquire a method base required to be called for the debugging type according to the debugging type, and generate a data architecture, for debugging correspondingly, as the debugging data.

In some examples, the remote debugging device 1200 further includes a collating device, configured to collate the first operating data or the second operating data to obtain key information; and to adjust the key information structurally to generate a target data architecture.

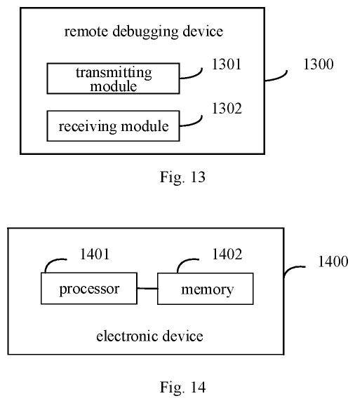

FIG. 13 is a schematic diagram showing a remote debugging device according to at least one of examples of the present disclosure. As shown in FIG. 13, the remote debugging device 1300 is installed at a client side, including a transmitting device 1301 and a receiving device 1302.

The transmitting device 1301 is configured to transmit first operating data of a controller.

The receiving device 1302 is configured to receive debugging data corresponding to a controller to be debugged, and debug the controller to be debugged according to the debugging data.

In some examples, the receiving device 1302 is further configured to transmit second operating data generated, by the controller to be debugged, during and/or after a debugging process.

In some examples, the operating data of the controller includes resource usage state data and/or configuration information of the controller to be debugged.

In some examples, the receiving device 1302 is further configured to parse the debugging data to generate discrete debugging data; process and regroup the discrete debugging data to generate regrouped debugging data; acquire a debugging type of the regrouped debugging data, acquire an event library required to be called for the debugging type according to the debugging type, and generate second operating data of the controller to be debugged; and transmit the second operating data.

To achieve the above examples, the present disclosure further provides in examples an electronic device 1400. As shown in FIG. 14, the electronic device 1400 includes: a processor 1401; and a memory 1402, communicated to the processor, where the memory 1402 has stored therein executable instructions that, when executed by the processor 1401, achieve a remote debugging method according to the above examples.

To achieve the above examples, the present disclosure further provides in examples a non-transitory computer-readable storage medium having stored therein computer executable instructions that, when executed by a computer, achieves a remote debugging method according to the above examples.

To achieve the above examples, the present disclosure further provides in examples a computer program product, including a computer program that, when executed by a processor, achieves a remote debugging method according to the above examples.

To achieve the above examples, the present disclosure further provides in examples a computer program, including a computer program code that, when executed by a computer, implements a remote debugging method according to the above examples.

It should be noted that the interpretation for a remote debugging method according to the above examples applies in a remote debugging device, an electronic device, a non-transitory computer-readable storage medium, a computer program product and a computer program according to the above examples, which will not be repeated herein.

In the specification, it should be understood that, the terms indicating orientation or position relationship such as “central”, “longitudinal”, “lateral”, “width”, “thickness”, “above”, “below”, “front”, “rear”, “right”, “left”, “vertical”, “horizontal”, “top”, “bottom”, “inner”, “outer”, “clockwise”, “counter-clockwise”, “axial”, “radial”, “circumferential” should be construed to refer to the orientation or position relationship as then described or as shown in the drawings. These terms are merely for convenience and concision of description and do not alone indicate or imply that the device or element referred to must have a particular orientation or must be configured or operated in a particular orientation. Thus, it cannot be understood to limit the present disclosure.

In addition, terms such as “first” and “second” are used herein for purposes of description and are not intended to indicate or imply relative importance or significance or impliedly indicate quantity of the embodiments referred to. Thus, the feature defined with “first” and “second” may include one or more this feature. In the description of the present disclosure, “a plurality of” means two or more than two this features, unless specified otherwise.

Reference throughout this specification to “an embodiment,” “some embodiments,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples. Besides, any different embodiments and examples and any different characteristics of embodiments and examples may be combined without contradiction.

1. A method for remote debugging, for a cloud server side, comprising:
receiving, at a receiving device, first operating data of a controller;
acquiring, by a data acquiring device, the first operating data of a controller to be debugged according to a debugging instruction, wherein the debugging instruction comprises a first identification of the controller to be debugged;
generating, by a data transmitting device, debugging data according to the first operating data; and
transmitting, by the data transmitting device, the debugging data to the controller to be debugged.

2. The method according to claim 1, wherein subsequent to transmitting the debugging data to the controller to be debugged, the method further comprises:
Receiving, at a receiving device, second operating data generated, by the controller to be debugged, during and/or after a debugging process; and
generating, by the data transmitting device, a debugging log of the controller to be debugged according to the second operating data.

3. The method according to claim 1, wherein the first operating data of the controller comprises resource usage state data and/or configuration information of the controller to be debugged.

4. The method according to claim 2, wherein transmitting the debugging data to the controller to be debugged, comprises:
determining a debugging link of the controller to be debugged according to the first identification of the controller to be debugged; and
transmitting the debugging data to the controller to be debugged through the debugging link.

5. The method according to claim 4, wherein subsequent to acquiring the first operating data of a controller to be debugged, the method further comprises:
determining a project identification of the controller to be debugged and a second identification of a client side to which the controller to be debugged belongs, according to the first identification of the controller to be debugged; and
generating the debugging link based on the first identification and the project identification of the controller to be debugged, and the second identification of a target client side to which the controller to be debugged belongs.

6. The method according to claim 5, wherein subsequent to acquiring the first operating data or the second operating data, the method further comprises:
determining whether the first operating data or the second operating data carries the project identification and the second identification of the client side; and
adding the project identification and/or the second identification into the first operating data or the second operating data in response to the determination that the project identification and/or the second identification of the client side are/is not carried.

7. The method according to claim 1, wherein prior to transmitting the debugging data to the controller to be debugged, the method further comprises:
acquiring a debugging type of the debugging instruction, acquiring a method base required to be called for the debugging type according to the debugging type, and generating a data architecture, for debugging correspondingly, as the debugging data.

8. The method according to claim 2, wherein subsequent to acquiring the first operating data or the second operating data, the method further comprises:
collating the first operating data or the second operating data to obtain key information; and
adjusting the key information structurally to generate a target data architecture.

9. A method for remote debugging, for a client side, comprising:
transmitting first operating data of a controller; and
receiving, at a receiving device, debugging data corresponding to a controller to be debugged, and debugging the controller to be debugged according to debugging data.

10. The method according to claim 9, wherein subsequent to receiving debugging data corresponding to a controller to be debugged, and debugging the controller to be debugged according to the debugging data, the method further comprises:
transmitting second operating data generated, by the controller to be debugged, during and/or after a debugging process.

11. The method according to claim 9, wherein operating data of the controller comprises resource usage state data and/or configuration information of the controller to be debugged.

12. The method according to claim 9, wherein subsequent to receiving debugging data corresponding to a controller to be debugged, the method further comprises:
parsing the debugging data to generate discrete debugging data;
processing and regrouping the discrete debugging data to generate regrouped debugging data;
acquiring a debugging type of the regrouped debugging data, acquiring an event library required to be called for the debugging type according to the debugging type, and generating second operating data of the controller to be debugged; and
transmitting the second operating data.

13. A remote debugging device, for a cloud server side, comprising:
a first receiving device, configured to receive first operating data of a controller;
a data acquiring device, configured to acquire the first operating data of a controller to be debugged according to a debugging instruction, wherein the debugging instruction comprises a first identification of the controller to be debugged; and
a data transmitting device, configured to generate debugging data according to the first operating data, and transmit the debugging data to the controller to be debugged.

14. The remote debugging device according to claim 13, for a client side, comprising:
a transmitting device, configured to transmit first operating data of a controller; and
a receiving device, configured to receive debugging data corresponding to a controller to be debugged, and debug the controller to be debugged according to the debugging data.

15. An electronic device, comprising:
at least one processor; and
a memory, communicated to said at least one processor,
wherein the memory has stored therein executable instructions that, when executed by said at least one processor, achieve a remote debugging method according to claim 1.

16. A non-transitory computer-readable storage medium having stored therein computer executable instructions that, when executed by a computer, achieves a remote debugging method according to claim 1.

17. A computer program product, comprising a computer program that, when executed by a processor, achieves a remote debugging method according to claim 1.

18. A computer program, comprising a computer program code that, when executed by a computer, implements a remote debugging method according to claim 1.

19. The computer program according to claim 18, wherein subsequent to transmitting the debugging data to the controller to be debugged further comprises:
receiving second operating data generated, by the controller to be debugged, during and/or after a debugging process; and
generating a debugging log of the controller to be debugged according to the second operating data.

20. The computer program according to claim 19, wherein the second operating data of the controller comprises resource usage state data and/or configuration information of the controller to be debugged.
